(19) United States
(12) Patent Application Publication
(10) Pub. No.: US 2007/0162314 A1
(43) Pub. Date: Jul. 12, 2007

(54) Multi-traveler flight pass

(76) Inventors: Gerald B. Gunn, Vancouver (CA); Charles D. McKee JR., Toronto (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/640,443

(22) Filed: Dec. 14, 2006

Related U.S. Application Data
(63) Continuation-in-part of application No. 11/082,184, filed on Mar. 15, 2005.
(60) Provisional application No. 60/820,569, filed on Jul. 27, 2006.

(51) Int. Cl. G06Q 10/00

(52) U.S. Cl. 705/5

(57) ABSTRACT

A method of managing a multi-traveler flight pass based on interaction with a user, comprising: allocating a bank of available air travel credit to the multi-traveler flight pass; associating air travel conditions with the multi-traveler flight pass; and, in response to receiving from the user data identifying a plurality of travelers associated with the multi-traveler flight pass, associating said plurality of travelers with the multi-traveler flight pass. Also, a method of booking air travel services by using a multi-traveler flight pass associated with (i) a pool of travelers; (ii) certain air travel conditions and (iii) a bank of air travel credit, comprising: receiving from a user an identification of a flight to be booked for a given traveler in said pool of travelers using the multi-traveler flight pass; booking said flight; and, responsive to said booking, deducting credit from said bank of air travel credit associated with the multi-traveler flight pass.

### CROSS-REFERENCE TO RELATED APPLICATIONS

The present invention CLAIMS THE BENEFIT under 35 USC §119(e) of prior U.S. provisional patent application Ser. No. 60/820,569 to Gunn et al., filed on Jul. 27, 2006, hereby incorporated by reference herein.

The present invention is a CONTINUATION-IN-PART of prior U.S. patent application Ser. No. 11/082,184 to Gunn et al., filed on Mar. 15, 2005, hereby incorporated by reference herein.

### FIELD OF THE INVENTION

The present invention relates generally to the advance purchase of air travel and, more specifically, to the advance purchase of air travel for entities such as corporations whose employees have a collective need to travel frequently.

### BACKGROUND

Certain types of travelers are in the situation where they expect to travel by air with some frequency but cannot predict exactly when such travel will occur. For such travelers, a flight pass product (such as is available from Air Canada) is convenient.

Corporations may have similar travel needs but these needs tend to apply more frequently to a pool of employees (e.g., a department) than they do to actual individuals. Thus, individualized flight passes are not sufficiently flexible to accommodate the needs of corporations.

### SUMMARY OF THE INVENTION

A first broad aspect of the present invention seeks to provide a method of managing a multi-traveler flight pass based on interaction with a user, comprising: allocating a bank of available air travel credit to the multi-traveler flight pass; associating air travel conditions with the multi-traveler flight pass; and, in response to receiving from the user data identifying a plurality of travelers associated with the multi-traveler flight pass, associating said plurality of travelers with the multi-traveler flight pass.

A second broad aspect of the present invention seeks to provide a method of booking air travel services by using a multi-traveler flight pass associated with (i) a pool of travelers; (ii) certain air travel conditions and (iii) a bank of air travel credit, comprising: receiving from a user an identification of a flight to be booked for a given traveler in said pool of travelers using the multi-traveler flight pass; booking said flight; and, responsive to said booking, deducting credit from said bank of air travel credit associated with the multi-traveler flight pass.

A third broad aspect of the present invention seeks to provide a computer-readable storage medium comprising computer-readable program code which, when interpreted by a computing apparatus, causes the computing apparatus to execute a method of vending air travel services. The computer-readable program code comprises: first computer-readable program code for causing the computing apparatus to create a bank of available air travel credit based on user specification of said bank; second computer-readable program code for causing the computing apparatus to assign a plurality of travelers with said bank based on user identification of said travelers; third computer-readable program code for causing the computing apparatus to reserve air travel for individual ones of the travelers, said air travel being associated with expended air travel credit; and fourth computer-readable program code for causing the computing apparatus to deduct spent air travel credit from said bank of available air travel credit.

A fourth broad aspect of the present invention seeks to provide a method of booking air travel services, comprising: interacting with an air travel service provider to cause creation by the air travel service provider of a bank of available air travel credit; providing to the travel service provider an identification of a plurality of travelers associated with said bank; and contacting the air travel service provider to book air travel for individual ones of the travelers, wherein booking of said air travel causes a reduction in the available air travel credit in said bank.

A fifth broad aspect of the present invention seeks to provide an air travel service application platform comprising: a first functional entity for allowing a first user to create a multi-traveler flight pass associated with pool of travelers and with certain air travel conditions; and a second functional entity for allowing a second user to book a flight for a given traveler in said pool of travelers in accordance with the air travel conditions associated with the multi-traveler flight pass.

A sixth broad aspect of the present invention seeks to provide an air travel service application platform comprising: means for allowing a first user to create a multi-traveler flight pass associated with (i) a pool of travelers; (ii) certain air travel conditions and (iii) a bank of available air travel credit; and means for allowing a second user to book a flight for a given traveler in said pool of travelers in accordance with the air travel conditions associated and under a condition of there being sufficient remaining air travel credit in said bank.

A seventh broad aspect of the present invention seeks to provide a storage medium storing data for access by an application platform being executed by a data processing apparatus. The data comprises a data structure that includes: information regarding an identifier of a specific multi-traveler flight pass; information regarding a pool of travelers associated with the specific multi-traveler flight pass; information regarding a remaining amount of air travel credit applicable towards flights that can be booked in association with the specific multi-traveler flight pass; information regarding air travel conditions associated with the specific multi-traveler flight pass.

An eighth broad aspect of the present invention seeks to provide a storage medium storing data for access by an application platform being executed by a data processing apparatus. The data comprises a data structure that includes: information regarding a user registered with an air travel service provider; and information regarding a role of the user with respect to a set of at least one multi-traveler flight pass, each associated with (i) a respective pool of travelers; (ii) respective air travel conditions and (iii) a respective bank of available air travel credit.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a block diagram depicting an air travel information technology infrastructure that supports the creation, purchase and management of multi-traveler flight passes in accordance with a non-limiting embodiment of the present invention;

FIG. 2A depicts a relationship among different roles that may be held by a user of the information technology infrastructure of FIG. 1;

FIG. 2B shows a data structure stored in a database in the information technology infrastructure of FIG. 1;

FIG. 3 is a flow diagram showing interaction among various components of the information technology infrastructure of FIG. 1 in a scenario where a flight is booked in association with a multi-traveler flight pass.

It is to be expressly understood that the description and drawings are only for the purpose of illustration of certain embodiments of the invention and are an aid for understanding. They are not intended to be a definition of the limits of the invention.

### DETAILED DESCRIPTION OF NON-LIMITING EMBODIMENTS

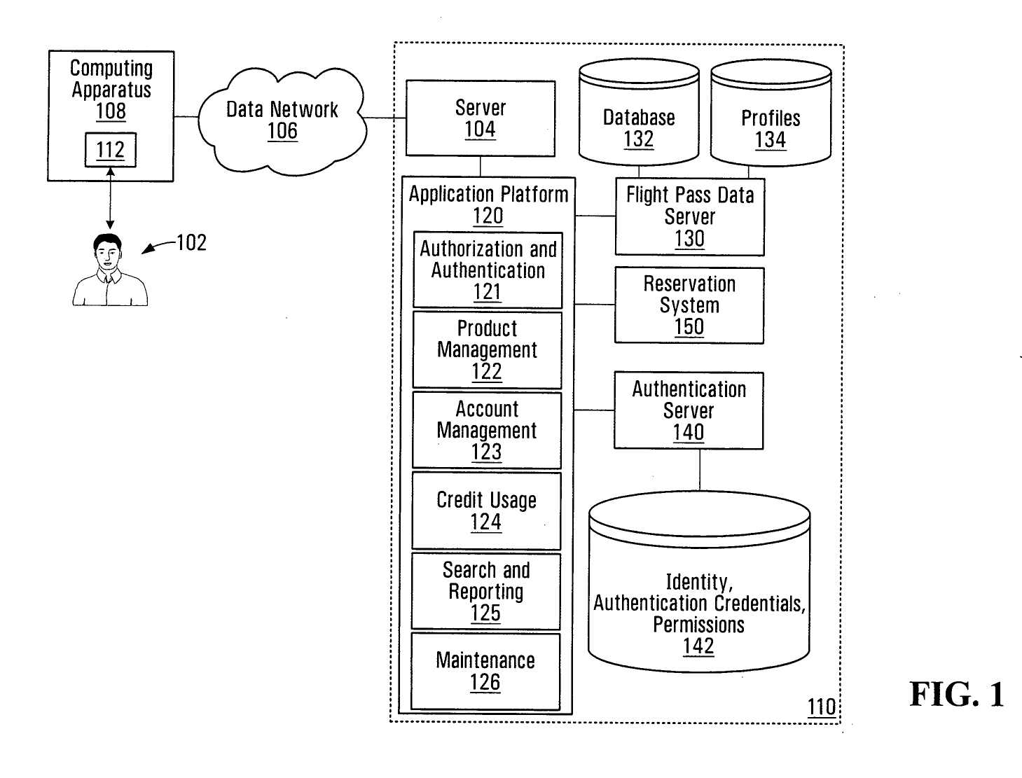

With reference to FIG. 1, non-limiting embodiments of the present invention will be described in the context of an air travel information technology (IT) infrastructure 110 including a server 104 that is accessible over a data network 106, non-limiting examples of which include the public Internet and a corporate intranet. The server 104 acts as a gateway between a computing apparatus 108 connected to the data network 106 and a remainder of the air travel IT infrastructure 110. In a non-limiting embodiment, the server 104 may comprise a web server, while the computing apparatus 108 may be a desktop PC, a laptop, a smart phone, a networked wireless personal communication device (such as Treo™, BlackBerry™), and so on.

The computing apparatus 108 is configured to execute a client software application 112 that interacts with the server 104 and also with a user 102 of the computing device 108. In an embodiment where the server 104 is a web server, the software application 112 executed by the computing apparatus 108 may be a conventional web browser or a customized program designed specifically to communicate with the server 104. The server 104 is configured to cause the software application 112 to interact with user 102, for example by implementing a graphical user interface (GUI). The server 104 cooperates with the software application 112 in order to allow user 102 to convey information to the air travel IT infrastructure 110, and to allow information from the air travel IT infrastructure 110 to be conveyed to user 102.

The air travel IT infrastructure 110 allows user 102 to effect various functions related to the creation, purchase and management of multi-traveler flight passes. In accordance with a non-limiting embodiment, a multi-traveler flight pass associates a shared bank of available air travel credit to a pool of two or more travelers, in accordance with certain air travel conditions. In accordance with an embodiment of the present invention, the air travel credit is applicable towards services (e.g., flights) offered by an air travel service provider (such as an airline company) or a network of air travel service providers (such as STAR ALLIANCE, for example). The air travel conditions associated with the multi-traveler flight pass may specify geographic and/or temporal constraints regarding the flights towards which the air travel credit is applicable. Non-limiting examples of geographic constraints include groups of origin and destination airport codes. Non-limiting examples of temporal constraints include a period of validity during which all air travel credit needs to be expended. Other constraints may be applicable without departing from the spirit of the invention. Also, it is within the scope of the invention for there to be no limit on the amount of air travel credit in the bank.

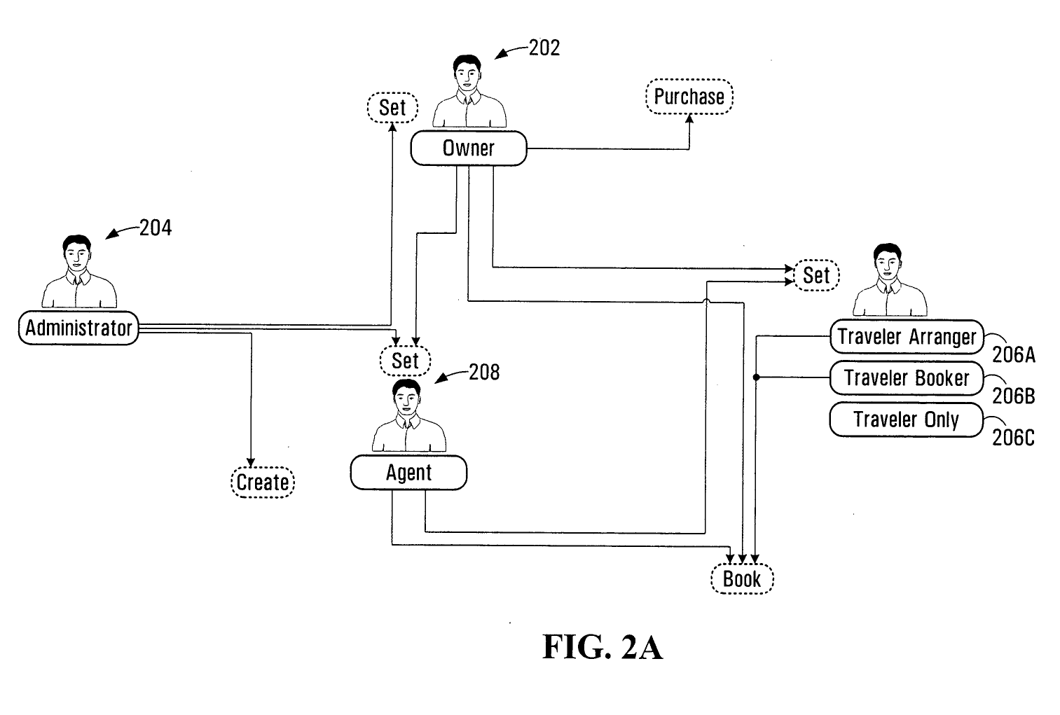

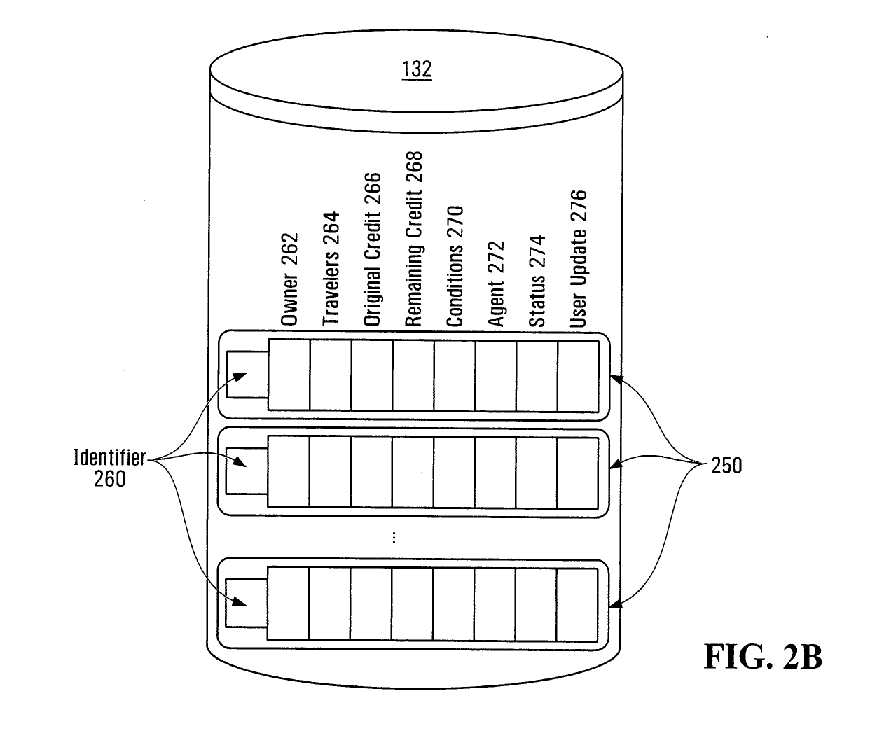

A given user (such as user 102) can have different capabilities with respect to a given multi-traveler flight pass, depending on the role of the given user, i.e., whether given user is a “traveler” 206A, 206B, 206C, an “agent” 208, an “owner” 202 or an “administrator” 204. With additional reference to FIG. 2A, these four categories of users (solid outline) and their respective capabilities (dashed outline) are can be described as follows:
The administrator 204, who is typically employed by the air travel service provider (such as an airline company), has a capability of assisting in the creation of a particular multi-traveler flight pass. The administrator 204 also has a capability of setting the identity of the owner 202 during creation of the particular multi-traveler flight pass. The administrator 204 also has a capability of setting the identity of the agent 208 during or after creation of the particular multi-traveler flight pass
The owner 202 has a capability of purchasing the particular multi-traveler flight pass. The owner 202 can also have a capability of setting the identity of travelers associated with the particular multi-traveler flight pass, which includes adding and revoking travelers. The owner 202 has a capability of booking flights for any of the travelers associated with the particular multi-traveler flight pass by drawing from the bank of air travel credit associated with the particular multi-traveler flight pass. The owner 202 can further have a capability of delegating the aforesaid booking and adding/revoking capabilities to a third party (e.g., the agent 208 or traveler 206A, known as a “traveler arranger”).
The traveler 206A, 206B, 206C is a person eligible to travel on flights booked using the bank of air travel credit associated with the particular multi-traveler flight pass. In addition, the traveler arranger 206A has a capability of booking flights for himself or herself, or on behalf of other travelers, by drawing from the bank of air travel credit associated with the particular multi-traveler flight pass. A traveler who is a “traveler booker” 206B has a capability of booking flights for himself or herself only. Finally, a traveler who is a “traveler only” 206B does not have a capability of booking flights for anyone, and merely enjoys the eligibility to permission to travel on flights booked for that traveler.
The agent 208 has a capability of booking flights for travelers by drawing from the bank of air travel credit associated with the particular multi-traveler flight pass. The agent 208 can also have a capability of setting the identity of the travelers associated with the particular multi-traveler flight pass.

It should be noted that in some situations, user 102 who is an administrator of one multi-traveler flight pass, may also be an administrator of other multi-traveler flight passes. In other situations, user 102 can be an administrator of one multi-traveler flight pass, while also being a traveler associated with another multi-traveler flight pass. In yet other situations, user 102 can be a traveler associated with several distinct multi-traveler flight passes.

Returning now to FIG. 1, in addition to comprising the server 104, the air travel IT infrastructure 110 includes an application platform 120, a flight pass data server 130, an authentication server 140 and a reservation system 150.

The authentication server 140 provides authentication services to various users (such as user 102) which, as stated earlier, can be travelers, agents, owners or administrators. To this end, the authentication server 140 comprises or has access to a database 142 that stores the identity of various pre-registered users, as well as associated authentication credentials and permissions. In a specific non-limiting embodiment, pre-registration of a given user can be by virtue of membership in a loyalty program administered by the air travel service provider or a third party. In a non-limiting embodiment, the “permissions” associated with a given user pertain to the activities that the given user is (or is not) allowed to perform. Accordingly, such permissions may include what functions or services the given user can perform and what data the given user is allowed to access. It will be appreciated that certain types of users (namely, travelers, agents and owners) may be external to the air travel IT infrastructure 110 and are likely to access the server 104 via the public internet, whereas certain other types of users (namely, administrators) may be internal to the air travel IT infrastructure 110 system and are likely to access the server 104 through a corporate intranet. Accordingly, different authentication protocols may be employed for these different scenarios.

The flight pass data server 130 stores multi-traveler flight pass data and profile data. With additional reference to FIG. 2B, the flight pass data server 130 comprises or has access to a database 132 that stores data pertaining to a plurality of multi-traveler flight passes 250. The data pertaining to each of the multi-traveler flight passes 250 can be viewed in one non-limiting embodiment as a respective record (or other data structure) that has a plurality of fields, including one or more of:
an identifier 260 of the respective one of the multi-traveler passes;
an owner field 262 that identifies the owner of the respective one of the multi-traveler flight passes 250. In a non-limiting example, the owner may be the travel coordinator (or travel department) of a corporation;
a travelers field 264 that identifies a pool (i.e., two or more) of travelers associated with the respective one of the multi-traveler flight passes 250. The number of travelers is not particularly limited, other than the fact that there are at least two travelers associated with the respective one of the multi-traveler flight passes 250;
an original credit field 266 (optional) that contains an indication of an original amount of air travel credit in the bank of air travel credit associated with the respective one of the multi-traveler flight passes 250. The original amount of air travel credit can be measured in a variety of ways such as units, flights, miles, dollars, etc.
a remaining credit field 268 that contains an indication of remaining available air travel credit in the bank of air travel credit associated with the respective one of the multi-traveler flight passes 250. The remaining credit field 268 fluctuates over time, and is reduced as flights are booked and can be increased by an administrator of the respective one of the multi-traveler flight passes 250, in order to compensate the owner of the respective one of the multi-traveler flight passes 250;
a conditions field 270 that specifies air travel conditions associated with the respective one of the multi-traveler flight passes 250. As stated earlier, the air travel conditions may include geographical and/or temporal constraints;
an agent field 272 that identifies one or more third parties (such as travel agents) that are authorized to perform actions on the respective one of the multi-traveler flight passes 250, such as the booking of flights;
a status field 274 that is indicative of a status (such as “active”, “hold”, “expired”, “inactive”, etc.) of the respective one of the multi-traveler flight passes 250; and
a user update field 276 (optional) that is indicative of a deadline (e.g., period of time or date/time) by which the travelers field 264 needs to be filled.

Other fields may be provided without departing from the spirit of the present invention.

The flight pass data server 130 comprises suitable circuitry, software and/or control logic for interacting with the database 132 to provide a service interface for accessing the multi-traveler flight passes 250. In this way, various fields of a given one of the multi-traveler flight passes 250 stored in the database 132 can be created, updated, modified, etc. by user 102, depending on the role of user 102 with respect to the given one of the multi-traveler flight passes 250.

In addition, the flight pass data server 130 comprises a profile database 134 that stores a profile of the various users (such as user 102). Thus, a given user who accesses the air travel IT infrastructure 110 will be associated with a profile stored in the profile database 134 that indicates to the given user which multi-traveler flight passes he or she can access and in what capacity (e.g., as owner, traveler arranger, traveler booker, traveler only, agent or administrator). Also, the profile database 134 stores indicia for the given user, such as country of residence, specific origin-destination combinations of interest to the given user, booking history, etc. The flight pass data server 130 thus also comprises suitable circuitry, software and/or control logic for interacting with the profile database 134 to provide a profile interface for accessing the profile database 134, in this way allowing the creation, updating and modification of various elements of a given user's profile stored in the profile database 134.

The reservation system 150 stores and manages availability and booking information and provides a service interface to verify flight availability, make bookings, change bookings and cancel bookings. The reservation system 150 can be an existing reservation system used by the air travel service provider, or it may be customized for optimized interaction with the other components of the air travel IT infrastructure 110.

The application platform 120 can be implemented using suitable software, hardware, control logic or a combination thereof, such as by means of a server, a server farm or other data processing apparatus, for example. The application platform 120 comprises various functional entities that provide various business functions. These functional entities include: an authentication and authorization functional entity 121, a product management functional entity 122, an account management functional entity 123, a credit usage functional entity 124, a search/reporting functional entity 125 and a maintenance functional entity 126.

The authentication and authorization functional entity 121 comprises suitable software, hardware and/or control logic for allowing users to login to the application platform 120 using authentication credentials, thus initiating a session. To this end, the authentication and authorization functional entity 121 interacts with the authentication server 140 to compare authentication credentials supplied by user 102 to those stored in the database 142. Upon successful authentication, the permissions associated with user 102 are retrieved from the database 142 and associated with the user for the purposes of the session. It is recalled that the authenticated user may be an owner of, a traveler associated with, an agent for, or an administrator of, a particular multi-traveler flight pass.

The product management functional entity 122 comprises suitable software, hardware and/or control logic for allowing an authenticated user (such as an administrator of an as yet uncreated multi-traveler flight pass) to interact with the flight pass data server 130 and create a new multi-traveler flight pass. Specifically, the authenticated user is given the opportunity to fill at least the owner field 262, the conditions field 270 and the original credit field 266 of the newly created multi-traveler flight pass. Thus, the authenticated user (i.e., the administrator) can identify the owner of the multi-traveler flight pass. Also, the geographical or temporal conditions will be specified, as will the amount of air travel credit associated with the multi-traveler flight pass.

The remaining credit field 268 of the newly created multi-traveler flight pass can be initialized to equal the contents of the original credit field 266. The user update field 276 (if applicable) is then filled at the time of creation of the multi-traveler flight pass to specify a time limit (such as 72 hours, for example) or date/time before expiry of which the eligible travelers field 264 needs to be filled. The agent field 272 of the particular multi-traveler flight pass also can but does not need to be filled upon creation of the multi-traveler flight pass. Also, upon creation of a particular multi-traveler flight pass, the product management functional entity 122 allows the administrator of the particular multi-traveler flight pass to set the status field 274 of the particular multi-traveler flight pass to “active” or to “hold” (while awaiting payment or identification of the travelers associated with the particular multi-traveler flight pass).

In addition, the product management functional entity 122 allows an authenticated user who is an administrator of a particular multi-traveler flight pass to delete the particular multi-traveler flight pass and/or to retrieve a list of multi-traveler flight passes for which the authenticated user is an administrator.

The account management functional entity 123 comprises suitable software, hardware and/or control logic for allowing an authenticated user who is an owner of a previously created multi-traveler flight pass to interact with the flight pass data server 130 and purchase the aforesaid multi-traveler flight pass. This can involve obtaining credit card information and causing a financial transaction to take place, either at the time of purchase or thereafter. Also, the account management functional entity 123 comprises suitable software, hardware and/or control logic for allowing an authenticated user who is an owner of, or an agent for, a particular multi-traveler flight pass to interact with the flight pass data server 130 and access the information in the travelers field 264 of the particular multi-traveler flight pass in order to add thereto a new traveler, revoke therefrom an existing traveler and/or retrieve the identity of the travelers associated with the particular multi-traveler flight pass. It is noted that in certain embodiments of the present invention (which may be appropriate for multi-traveler passes targeting small and medium enterprises), new travelers cannot be added to the travelers field 264 beyond a default period of time or a date/time specified in the user update field 276, while in other embodiments of the present invention (which may be appropriate for multi-traveler passes targeting large corporations), there is no such restriction on adding new travelers to the travelers field 264.

Furthermore, the account management functional entity 123 comprises suitable software, hardware and/or control logic for allowing an authenticated user who is an owner of, or an agent for, a particular multi-traveler flight pass to interact with the flight pass data server 130 and access, retrieve and/or view the information in the status field 274 of the particular multi-traveler flight pass. In addition, the account management functional entity 123 comprises suitable software, hardware and/or control logic for allowing an authenticated user who is an owner of a particular multi-traveler flight pass to interact with the flight pass data server 130 and access the agent field 272 of the particular multi-traveler flight pass in order to add thereto a new agent and/or revoke therefrom an existing agent for the particular multi-traveler flight pass.

The credit usage functional entity 124 comprises suitable software, hardware and/or control logic to allow an authenticated user who is an owner of, or a traveler associated with, a particular multi-traveler flight pass to interact with the flight pass data server 130 and the reservation system 150 in order to book a flight using the available air travel credit associated with the particular multi-traveler flight pass.

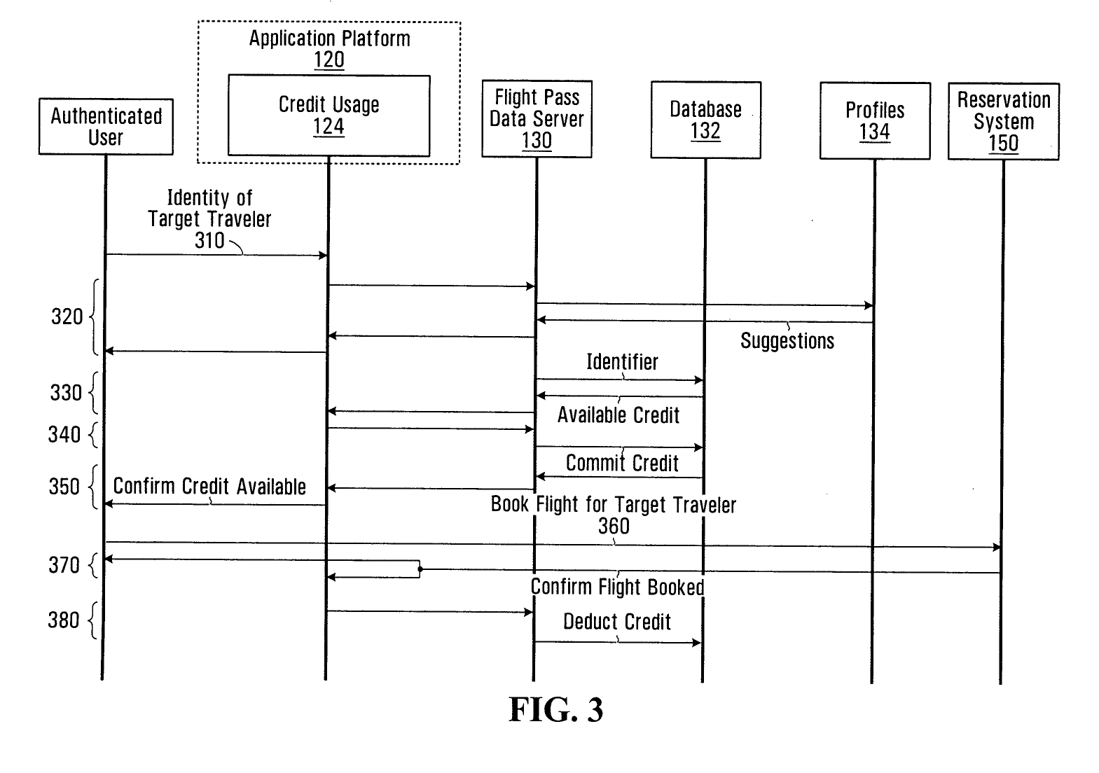

Specifically, and with reference to FIG. 3, at step 310 the credit usage functional entity 124 receives from the authenticated user the identifier of the particular multi-traveler flight pass and the identity of one of the travelers associated with the particular multi-traveler flight pass and for whom the flight is to be booked. The identified traveler is hereinafter referred to as a “target traveler”. At step 320, the credit usage functional entity 124 may optionally interact with the flight pass data server 130 to obtain from the profile database 134 suggestions for the authenticated user that are based on a historical travel pattern for the target traveler. At step 330, the credit usage functional entity 124 interacts with the flight pass data server 130 to provide the identifier of the particular multi-traveler flight pass to the database 132 in order to determine whether sufficient air travel credit remains in the remaining credit field 268 of the particular multi-traveler flight pass.

If so, at step 340, the credit usage functional entity 124 causes the flight pass data server 130 to commit a suitable amount of air travel credit to the particular multi-traveler flight pass and to cause this to be reflected in the remaining credit field 268 in the database 132. At step 350, the credit usage functional entity 124 informs the authenticated user that he or she may proceed with booking a flight for the target II traveler. (Alternatively, if there was not enough available air travel credit, then an error/denial message could be returned to the authenticated user.) At step 360, the authenticated user contacts the reservation system 150 and attempts to book a flight for the target traveler. Assuming that the flight is available, the authenticated user causes the reservation system 150 to book the flight. At step 370, the reservation system 150 issues a confirmation to both the authenticated user and the credit usage functional entity 124 that the flight has been booked. At step 380, the credit usage functional entity 124 interacts with the flight pass data server 130 to update the database 132 in order to deduct the previously committed amount of air travel credit from the remaining credit field 268 of the particular multi-traveler flight pass by a suitable amount.

In addition to allowing the booking of flights, the credit usage functional entity 124 also comprises suitable software, hardware and/or control logic to allow an authenticated user who is an owner of, or a traveler associated with, a particular multi-traveler flight pass to interact with the flight pass data server 130 and the reservation system 150 in order to update, view or cancel bookings made in the previously described manner.

The search and reporting functional entity 125 comprises suitable software, hardware and/or control logic to allow an authenticated user who is an owner or an administrator of a particular multi-traveler flight pass to interact with the flight pass data server 130 in order to search credit usage, generate a summary usage report, and view a booking history or booking archives.

Finally, the maintenance functional entity 126 comprises suitable software, hardware and/or control logic to allow an authenticated user who is an administrator of a particular multi-traveler flight pass to interact with the flight pass data server 130 in order to modify the information in the owner field 262 and/or the remaining credit field 268 and/or a conditions field 270, the status field 274 and/or the user update field 276 of the particular multi-traveler flight pass. In this way, the administrator of the particular multi-traveler flight pass can add complementary air travel credit, change the expiry date associated with the particular multi-traveler flight pass, extend or shorten the length of time permitted to add new travelers, and make other modifications.

Thus, methods and systems that allow the creation and purchase of a multi-traveler flight pass have been described and illustrated. It can be appreciated that the teachings provided herein enable an organization to purchase air travel credit towards flights in advance, with sufficient flexibility to allow the air travel credit to be shared among a pool of travelers (such as employees of the corporation or members of a department).

Naturally, while specific embodiments of the present invention have been described and illustrated, those skilled in the art will appreciate that numerous modifications and variations can be made without departing from the scope of the invention as defined in the appended claims.

1. A method of managing a multi-traveler flight pass based on interaction with a user, comprising:
allocating a bank of available air travel credit to the multi-traveler flight pass;
associating air travel conditions with the multi-traveler flight pass;
in response to receiving from the user data identifying a plurality of travelers associated with the multi-traveler flight pass, associating said plurality of travelers with the multi-traveler flight pass.

2. The method defined in claim 1, further comprising:
providing the user with an opportunity to electronically express a desire to purchase the multi-traveler flight pass;
causing a financial transaction to take place.

3. The method defined in claim 1, further comprising:
rendering said air travel credit available to be applied towards air travel for any traveler in said pool of travelers in accordance with the air travel conditions associated with the multi-traveler flight pass.

4. The method defined in claim 1, wherein said air travel conditions comprise geographic constraints regarding the air travel towards which said air travel credit is applicable.

5. The method defined in claim 1, wherein said air travel conditions comprise temporal constraints regarding the air travel towards which said air travel credit is applicable.

6. The method defined in claim 1, wherein said air travel conditions comprise temporal and geographic constraints regarding the air travel towards which said air travel credit is applicable.

7. The method defined in claim 1, further comprising:
receiving from the user an identification of a particular traveler associated with the multi-traveler flight pass;
receiving from the user an indication of a desire to remove said particular traveler from said pool of travelers;
updating the pool of travelers to remove said particular traveler therefrom.

8. The method defined in claim 1, further comprising:
receiving from the user an identification of a new traveler associated with the multi-traveler flight pass;
receiving from the user an indication of a desire to add said particular traveler to said pool of travelers;
updating the pool of travelers to add said new traveler thereto.

9. A method of booking air travel services by using a multi-traveler flight pass associated with (i) a pool of travelers; (ii) certain air travel conditions and (iii) a bank of air travel credit, comprising:
receiving from a user an identification of a flight to be booked for a given traveler in said pool of travelers using the multi-traveler flight pass;
booking said flight;
responsive to said booking, deducting credit from said bank of air travel credit associated with the multi-traveler flight pass.

10. The method defined in claim 9, further comprising:
receiving from an owner of the multi-traveler flight pass an indication that a given user is authorized to book flights for travelers in said pool of travelers using the multi-traveler flight pass;
adding the given user as an agent for the multi-traveler flight pass

11. The method defined in claim 10, further comprising:
determining if the user is either an owner of the multi-traveler flight pass or the given traveler in said pool of travelers; and
performing said booking only if the user is either an owner of the multi-traveler flight pass or the given traveler in said pool of travelers.

12. The method defined in claim 10, further comprising:
determining whether the user is an owner of the multi-traveler flight pass or an agent for the multi-traveler flight pass;
performing said booking only if the user is either an owner of the multi-traveler flight pass or an agent for the multi-traveler flight pass.

13. The method defined in claim 1, further comprising:
determining whether the user is an owner of the multi-traveler flight pass or an agent for the multi-traveler flight pass;
performing said booking only if the user is either an owner of the multi-traveler flight pass or the given traveler in said pool of travelers or an agent for the multi-traveler flight pass.

14. The method defined in claim 1, the method further comprising:
receiving from a given traveler in said pool of travelers an identification of a flight to be booked for said given traveler using the multi-traveler flight pass;
determining whether said given traveler is designated as at least one of a traveler arranger and a traveler booker for the multi-traveler flight pass;
booking said flight only if said given traveler is designated as at least one of a traveler arranger and a traveler booker for the multi-traveler flight pass;
responsive to said booking, deducting credit from said bank of air travel credit associated with the multi-traveler flight pass.

15. The method defined in claim 14, wherein the given user is a travel agent.

16. The method defined in claim 14, further comprising:
receiving from the user an indication that a given agent for the multi-traveler flight pass is no longer authorized to book flights for travelers in said pool of travelers using the multi-traveler flight pass;
accessing the database to remove the given agent as an agent for the multi-traveler flight pass.

17. The method defined in claim 1, further comprising:
receiving from an administrator a request to credit the multi-traveler flight pass;
crediting said bank of air travel credit associated with the multi-traveler flight pass.

18. The method defined in claim 17, wherein the user is said administrator.

19. A computer-readable storage medium comprising computer-readable program code which, when interpreted by a computing apparatus, causes the computing apparatus to execute a method of vending air travel services, the computer-readable program code comprising:
first computer-readable program code for causing the computing apparatus to create a bank of available air travel credit based on user specification of said bank;
second computer-readable program code for causing the computing apparatus to assign a plurality of travelers with said bank based on user identification of said travelers;
third computer-readable program code for causing the computing apparatus to reserve air travel for individual ones of the travelers, said air travel being associated with expended air travel credit;
fourth computer-readable program code for causing the computing apparatus to deduct spent air travel credit from said bank of available air travel credit.

20. A method of booking air travel services, comprising:
interacting with an air travel service provider to cause creation by the air travel service provider of a bank of available air travel credit;
providing to the travel service provider an identification of a plurality of travelers associated with said bank;
contacting the air travel service provider to book air travel for individual ones of the travelers, wherein booking of said air travel causes a reduction in the available air travel credit in said bank.

21. The method defined in claim 1, further comprising:
purchasing said bank of available air travel credit.

22. The method defined in claim 21, wherein said purchasing occurs after said providing.

23. The method defined in claim 21, further comprising:
changing the identification of at least one of the plurality of travelers associated with said bank.

24. The method defined in claim 23, wherein said changing occurs before said purchasing.

25. The method defined in claim 23, wherein said changing occurs after said purchasing.

26. The method defined in claim 20, wherein at least one of said interacting, providing and contacting is effected over a data network.

27. The method defined in claim 20, wherein at least one of said interacting, providing and contacting is effected over the Internet.

28. An air travel service application platform comprising:
a first functional entity for allowing a first user to create a multi-traveler flight pass associated with pool of travelers and with certain air travel conditions; and
a second functional entity for allowing a second user to book a flight for a given traveler in said pool of travelers in accordance with the air travel conditions associated with the multi-traveler flight pass.

29. The air travel service application platform defined in claim 28, further comprising:
a third functional entity for managing credit information regarding the multi-traveler flight pass, said third functional entity being configured to update the credit information regarding the multi-traveler flight pass as a result of said flight having been booked.

30. The air travel service application platform defined in claim 29, wherein the credit information regarding the further multi-traveler flight pass includes an amount of available air travel credit associated with the multi-traveler flight pass.

31. The air travel service application platform defined in claim 29, further comprising:
a fourth functional entity for managing traveler information regarding the multi-traveler flight pass, said fourth functional entity being configured to update the traveler information regarding the multi-traveler flight pass based on input from a user who is an administrator or an owner of the multi-traveler flight pass.

32. The air travel service application platform defined in claim 31, further comprising:
a fifth functional entity for authenticating the user to determine whether the user is an administrator or an owner of the multi-traveler flight pass.

33. The air travel service application platform defined in claim 28, wherein said platform is accessible to the first and second users over at least one data network.

34. An air travel service application platform comprising:
means for allowing a first user to create a multi-traveler flight pass associated with (i) a pool of travelers; (ii) certain air travel conditions and (iii) a bank of available air travel credit; and
means for allowing a second user to book a flight for a given traveler in said pool of travelers in accordance with the air travel conditions associated and under a condition of there being sufficient remaining air travel credit in said bank.

35. A storage medium storing data for access by an application platform being executed by a data processing apparatus, the data comprising a data structure that includes:
information regarding an identifier of a specific multi-traveler flight pass;
information regarding a pool of travelers associated with the specific multi-traveler flight pass;
information regarding a remaining amount of air travel credit applicable towards flights that can be booked in association with the specific multi-traveler flight pass;
information regarding air travel conditions associated with the specific multi-traveler flight pass.

36. The storage medium defined in claim 35, wherein the data structure further includes information regarding an owner of the specific multi-traveler pass.

37. The storage medium defined in claim 36, wherein the data structure further includes information regarding an agent authorized to perform actions related to the specific multi-traveler pass.

38. The storage medium defined in claim 37, wherein the data structure further includes information an original amount of air travel credit applicable towards flights that can be booked in association with the specific multi-traveler flight pass.

39. The storage medium defined in claim 38, wherein the data structure further includes information regarding a status of the specific multi-traveler flight pass.

40. The storage medium defined in claim 39, wherein the data structure further includes information regarding a deadline for identification of the travelers in the pool of travelers associated with the specific multi-traveler flight pass.

41. A storage medium storing data for access by an application platform being executed by a data processing apparatus, the data comprising a data structure that includes:
information regarding a user registered with an air travel service provider; and
information regarding a role of the user with respect to a set of at least one multi-traveler flight pass, each associated with (i) a respective pool of travelers; (ii) respective air travel conditions and (iii) a respective bank of available air travel credit.

42. The storage medium defined in claim 41, the data further including information regarding the set of at least one multi-traveler flight pass.

43. The storage medium defined in claim 41, wherein the role of the user with respect to a given multi-traveler flight pass in the set of at least one multi-traveler flight pass is one of: an administrator, an owner, a traveler and an agent.

44. The storage medium defined in claim 41, wherein the role of the user with respect to a given multi-traveler flight pass in the set of at least one multi-traveler flight pass is one of: an administrator, an owner, a traveler arranger, a traveler booker, a traveler only and an agent.

45. The storage medium defined in claim 44, wherein when the role of a traveler arranger is characterized by the user being permitted to book flights for the user and at least one other traveler from the pool of travelers using the multi-traveler flight pass.

46. The storage medium defined in claim 45, wherein when the role of a traveler booker is characterized by the user being permitted to book flights for the user and no other traveler from the pool of travelers using the multi-traveler flight pass.

47. The storage medium defined in claim 46, wherein when the role of a traveler only is characterized by the user being permitted to travel on flights booked using the multi-traveler flight pass but not being permitted to book any flight using the multi-traveler flight pass.
